(19) United States
(12) Patent Application Publication
(10) Pub. No.: US 2019/0375959 A1
(43) Pub. Date: Dec. 12, 2019

(54) PIGMENT DISPERSIONS

(71) Applicant: HEWLETT-PACKARD DEVELOPMENT COMPANY, L.P., Spring, TX (US)

(72) Inventors: Kai-Kong IU, San Diego, CA (US); Stone S. OUYANG, San Diego, CA (US); Shao-Wei LI, San Diego, CA (US); Shonna Anne DAWN, San Diego, CA (US); Dennis Z. GUO, San Diego, CA (US)

(73) Assignee: Hewlett-Packard Development Company, L.P., Spring, TX (US)

(21) Appl. No.: 16/463,128

(22) PCT Filed: Apr. 7, 2017
(86) PCT No.: PCT/US2017/026531

§ 371 Date: May 22, 2019

(51) Int. Cl. C09D 17/00; C09D 11/322; C09D 11/037; C09D 11/033

(52) U.S. Cl. CPC C09D 17/003; C09D 17/001; C09D 11/033; C09D 11/037; C09D 11/322

(57) ABSTRACT

The present disclosure is drawn to pigment dispersions including from 5 wt % to 30 wt % of a pigment having an amide group, a styrene acrylic polymer having a weight average molecular weight from 3,000 Mw to 30,000 Mw and having a weight ratio to the pigment of from 1:1 to 1:10, a lactam co-solvent having a weight ratio to the pigment of from 10:1 to 1:10, and water. The lactam co-solvent can be co-milled with the pigment and an at least 5 wt % portion of the lactam co-solvent can be adsorbed on the pigment via van der waals interaction with the amide group.

### BACKGROUND

There are several reasons that inkjet printing has become a popular way of recording images on various media surfaces, particularly paper. Some of these reasons include low printer noise, capability of high-speed recording, and multi-color recording. Additionally, these advantages can be obtained at a relatively low price to consumers. Though there has been great improvement in inkjet printing, accompanying this improvement are increased demands by consumers, e.g., higher speeds, higher resolution, full color image formation, increased stability, large format printing, etc.

### BRIEF DESCRIPTION OF THE DRAWING

FIG. 1 is a flowchart illustrating an example method of manufacturing a pigment dispersion in accordance with examples of the present disclosure.

### DETAILED DESCRIPTION

The present disclosure is drawn to pigment dispersions, methods of manufacturing pigment dispersions, and inks including pigment dispersions. Some pigment-based inks suffer from poor temperature cycle stability and relatively short shelf-life. For example, the shelf-life of a pigment-based ink can be affected by aggregation of pigment particles within the ink vehicle, thus causing the pigment aggregates to precipitate out of the ink vehicle. As such, many ink manufacturers have employed various processes, such as high shear mixing, to reduce initial pigment aggregation and finely disperse the pigment during manufacturing. However, despite these efforts, in some cases, the pigment particles can re-aggregate over time. Further, this re-aggregation process can be accelerated when the inks are exposed to temperature cycling (e.g. freeze-thaw cycling, for example) during transportation, storage, or the like. The pigment dispersions described herein can help address some of these challenges and can provide ink dispersions and associated inks with increased temperature cycle stability and shelf-life.

For example, the pigment dispersions described herein can include from about 5 wt % to about 30 wt % of a pigment having an amide group. The pigment dispersion can also include a styrene acrylic polymer having a weight average molecular weight (Mw) from about 3,000 Mw to about 30,000 Mw and having a weight ratio to the pigment of from 1:1 to 1:10, a lactam co-solvent having a weight ratio to the pigment of from 10:1 to 1:10, and water. The lactam co-solvent can be co-milled with the pigment and an at least 5 wt % portion of the lactam co-solvent can be adsorbed on the pigment via van der waals interactions with the amide group on the pigment.

In further detail, with respect to the pigment, a variety of suitable pigments having an amide group can be used, and in some examples, the amide group can be part of an n-phenyl amide group. Non-limiting examples of pigments that have an n-phenyl amide group include Pigment Orange 43, Pigment Yellow 155, Pigment Yellow 74, Pigment Orange 34, Pigment Red 149, Pigment Red 269, or Pigment Yellow 14. In one specific example, the pigment can include an amide group with a tertiary amine, such as Pigment Orange 43, Pigment Orange 34, Pigment Red 149, or Pigment Yellow 14. In other examples, the pigment can include multiple amide groups or even multiple n-phenyl amide groups, such as Pigment Orange 43, Pigment Yellow 14, Pigment Red 269, Pigment Red 149, and Pigment Orange 34.

Typically, the pigment can be present in the pigment dispersion at a concentration from about 5 wt % to about 30 wt %. In other examples, the pigment can be present in the pigment dispersion in an amount from about 8 wt % to about 25 wt %, or from about 10 wt % to about 20 wt %.

As mentioned, a styrene acrylic polymer can be included in the pigment dispersion. A variety of styrene acrylic polymers can be used. Some non-limiting commercial examples of useful styrene acrylic polymers are sold under the trade names Joncryl® (S.C. Johnson Co.), Ucar™ (Dow Chemical Co.), Jonrez® (MeadWestvaco Corp.), and Vancryl® (Air Products and Chemicals, Inc.).

In further detail, the styrene acrylic polymer can be present at 1 wt % to 10 wt %, example. Furthermore, the styrene acrylic polymer can be formulated with a variety of monomers, such as hydrophilic monomers, hydrophobic monomers, etc. Non-limiting examples of hydrophilic monomers that can be co-polymerized together to form the styrene acrylic polymer include acrylic acid, methacrylic acid, ethacrylic acid, dirnethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic add, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, the like, or combinations thereof.

Non-limiting examples of hydrophobic monomers that can be used include styrene, p-methyl styrene, methyl methacrylate, hexyl acrylate, hexyl methacrylate, butyl acrylate, butyl methacrylate, ethyl acrylate, ethyl methacrylate, propyl acrylate, propyl methacrylate, octadecyl acrylate, octadecyl methacrylate, stearyl methacrylate, vinylbenzyl chloride, isobornyl acrylate, tetrahydrofurfuryl acrylate, 2-phenoxyethyl methacrylate, ethoxylated nonyl phenol methacrylate, isobornyl methacrylate, cyclohexyl methacrylate, t-butyl methacrylate, n-octyl methacrylate, lauryl methacrylate, trydecyl methacrylate, alkoxylated tetrahydrofurfuryl acrylate, isodecyl acrylate, isobornylmethacrylate, the like, or combinations thereof.

Typically, the styrene acrylic polymer can have a weight average molecular weight (Mw) from about 1,000 Mw to about 30,000 Mw. In yet other examples, the styrene acrylic polymer can have an Mw from about 3,000 to about 20,000, or from about 5,000 to about 15,000. It is noted that molecular weights of polymers will be periodically referred to throughout the current disclosure. In each instance where molecular weight is used, it is to be understood that this refers to weight average molecular weight.

Further, in some examples, the styrene acrylic polymer can have an acid number or acid value from about 100 mg/g to about 300 mg/g. In yet other examples, the styrene acrylic polymer can have an acid number from about 110 mg/g to about 180 mg/g, from about 130 mg/g to about 200 mg/g, or from about 150 mg/g to about 170 mg/g. An acid number can be defined as the number of milligrams of potassium hydroxide required to neutralize 1 gram of the substance.

In some examples, the amount of styrene acrylic polymer in the pigment dispersion can be based on the amount of pigment present. Thus, in some examples, the styrene acrylic polymer and the pigment can be present in the pigment dispersion at a particular weight ratio. In some specific examples, the styrene acrylic polymer and the pigment can be present at a weight ratio of from 1:1 to 1:10 styrene acrylic polymer to pigment. In other examples, the styrene acrylic polymer and pigment can be present at a weight ratio of from about 1:1 to about 1:8 styrene acrylic polymer to pigment. In yet other examples, the styrene acrylic polymer and the pigment can be present at a weight ratio of from about 1:2 to about 1:6 styrene acrylic polymer to pigment. In yet other examples, the styrene acrylic polymer can be present in the pigment dispersion in an amount from about 1 wt % to about 10 wt %. In still additional examples, the styrene acrylic polymer can be present in the pigment dispersion in an amount from about 2 wt % to about 8 wt %.

The pigment dispersion can also include a lactam co-solvent(s). Lactam compounds can generally refer to a variety of cyclic amide compounds, such as α-lactams (3 ring atoms), β-lactams (4 ring atoms), γ-lactams (5 ring atoms), δ-lactams (6 ring atoms), ε-lactams (7 ring atoms), etc. Thus, the lactam co-solvent can include various α-lactams, β-lactams, γ-lactams, δ-lactams, ε-lactams, the like, or combinations thereof. In some specific examples, the lactam co-solvent can include a γ-lactam co-solvent. Some non-limiting examples of γ-lactam co-solvents can include 2-pyrrolidone, 1-methyl-2 pyrrolidone, 2-hydroxyethyl-2-pyrrolidone, hydantoin, di-(2-hydroxyethyl)-5,5-dimethylhydantoin, derivatives thereof, the like, or combinations thereof. In some specific examples, the lactam co-solvent can have a structure according to Formula I:

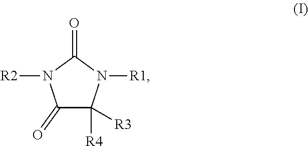

where R1 and R2 are independently selected from H or a C₁-C₆ hydroxy alkyl group, and where R3 and R4 are independently selected from H or a C₁-C₃ alkyl group. In one specific example, at least one of R1-R4 can be other than H. In some examples, R1 or R2 can be CH₂CH₂OH. In some further examples, R1 and R2 can be CH₂CH₂OH. In yet additional examples, R3 or R4 can be a methyl group. In some further examples, R3 and R4 can be methyl.

In some examples, the lactam co-solvent(s) can adsorb onto pigments having amide groups via van derwaals interactions. As used herein, “van der waals interaction” refers to any chemical bond other than ionic or covalent bonds. Thus, “van derwaals interactions” can include hydrogen bonding, dipole-dipole interactions, and any other suitable intermolecular interaction other than ionic and covalent bonding. For example, an at least 5 wt % portion of the lactam co-solvent can be adsorbed on the pigment, e.g., ranging from 5 wt % to 40 wt %, 10 wt % to 40 wt %, 5 wt % to 30 wt %, 10 wt % to 30 wt %, or from 15 wt % to 30 wt % of the lactam co-solvent that becomes adsorbed on the pigment. By way of illustration, an example γ-lactam can adsorb onto Pigment Orange 43 via van derwaals interactions as follows:

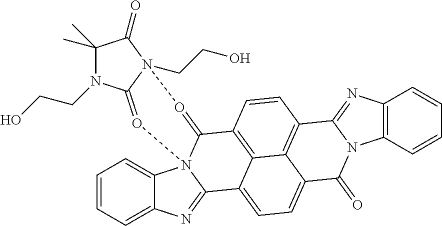

This intermolecular interaction between the lactam co-solvent and the pigment having an amide group can help prevent re-aggregation of the pigment particles and associated precipitation. Thus, the van der waals interactions between the lactam co-solvent and the pigment having an amide group can help increase the temperature cycle stability and shelf life of the pigment dispersion and associated ink. Notably, pigment orange 43 includes two amide groups, and in further detail, the two amide groups of Pigment Orange 43 are part of an n-phenyl amide group. For clarity, the structure of an n-phenyl amide group, which can be present as a portion or moiety of the pigment structure, is shown as follows in Formula II:

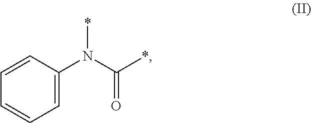

where the asterisks (*) indicate bonds that are not part of the n-phenyl amide group per se, but which attach to other atoms or moieties within the structure. For example, using Pigment Orange 43 shown above as an example, the asterisk bond attached to the nitrogen (N) is part of a 5-membered di-nitrogen ring moiety within the structure, and the asterisk bond attached to the carbon (C) is attached to a naphthalene moiety within the structure. Other groups can also be attached to the phenyl group moiety, for example.

In some instances, the manner in which the lactam co-solvent and the pigment are combined can affect the extent to which these intermolecular interactions occur. For example, in some cases, where the lactam co-solvent is merely added as a vehicle co-solvent, adsorption of the lactam co-solvent onto the pigment may not occur. In contrast, where the lactam co-solvent is co-milled with the pigment having an amide group as a milling co-solvent, the van der waals interactions between the lactam co-solvent and the pigment can be appreciable. For example, the portion of the lactam co-solvent that may be adsorbed on the pigment can be from about 5 wt % to about 50 wt % or more of the lactam co-solvent. In some additional examples, the portion of the lactam co-solvent that is adsorbed on the pigment can be from about 10 wt % to about 40 wt % or more of the lactam co-solvent. In yet other examples, the portion of the lactam co-solvent that is adsorbed on the pigment can be from about 15 wt % to about 30 wt % or more of the lactam co-solvent. For clarity, these percentages are not the percentage of lactam co-solvent in the in the dispersion or ink, but rather the percentage of lactam co-solvent that is present that becomes adsorbed on the pigment by van der waals forces.

In some examples, the amount of lactam co-solvent in the pigment dispersion can be based on the amount of pigment present. Thus, in some examples, the lactam co-solvent and the pigment can be present in the pigment dispersion at a particular weight ratio. In some specific examples, the lactam co-solvent and the pigment can be present at a weight ratio of from 10:1 to 1:10 lactam co-solvent to pigment. In other examples, the lactam co-solvent and pigment can be present at a weight ratio of from about 5:1 to about 1:5 lactam co-solvent to pigment. In yet other examples, the lactam co-solvent and the pigment can be present at a weight ratio of from about 2:1 to about 1:3 lactam co-solvent to pigment. In yet other examples, the lactam co-solvent can be present in the pigment dispersion in an amount from about 5 wt % to about 25 wt %. In still additional examples, the lactam co-solvent can be present in the pigment dispersion in an amount from about 8 wt % to about 20 wt %.

As previously discussed, the pigment dispersion can also include water. In some examples, the water can be present in an amount from 40 wt % to about 90 wt %. In other examples, the pigment dispersion can include from about 60 wt % to about 80 wt % water. In further examples, the pigment dispersion can include from about 50 wt % to about 70 wt % water.

The pigment dispersion can also include a variety of other components, as desirable. Non-limiting examples can include a pH adjuster, a neutralizing agent, a buffer, a biocide, other suitable co-solvents or additives, the like, or combinations thereof.

Suitable pH adjuster can also be included. For example, a pH adjuster can be present such as either (or both) organic or inorganic acids, and organic or inorganic bases. In some specific examples, the pH adjuster can include hydrochloric acid, phosphoric acid, sodium hydroxide, potassium hydroxide, acetic acid, citric acid, ammonia, triethylamine, the like, or combinations thereof.

In some examples, the pigment dispersion can include a neutralizing agent. A variety of neutralizing agents can be used to neutralize the styrene acrylic polymer. Non-limiting examples can include an alkali hydroxide (e.g. potassium hydroxide, sodium hydroxide, lithium hydroxide, or the like, or combinations thereof), ammonium hydroxide, an organic amine, the like, or a combination thereof.

In some examples, the pigment dispersion can also include a pH buffer. Any suitable pH buffer can be included in the pigment dispersion. Non-limiting examples can include phosphate buffers, citrate buffers, phosphonate buffers, the like, or combinations thereof.

In additional examples, the pigment dispersion can include a biocide for inhibiting growth of undesirable microorganisms. Several non-limiting examples of suitable biocides include benzoate salts, sorbate salts, and commercial products such as Nuosept®, Ucarcide®, Vancide®, Proxel® GXL, Anticide® B20 or M20, Kordex® MLX, for example.

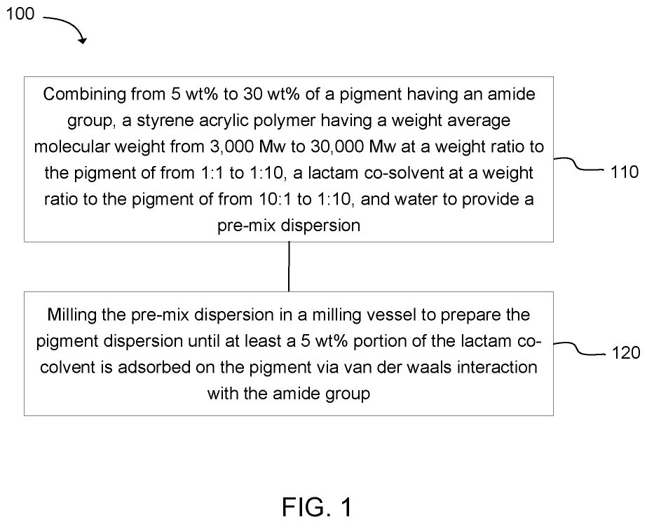

A method of manufacturing a pigment dispersion is also described herein. This is generally represented by the flow chart illustrated in FIG. 1. More specifically, FIG. 1 illustrates a method 100 of manufacturing a pigment dispersion. The method can include the step of combining 110 from 5 wt % to 30 wt % of a pigment having an amide group, a styrene acrylic polymer having a weight average molecular weight from 1,000 Mw to 30,000 Mw at a styrene acrylic polymer to pigment weight ratio from 1:1 to 1:10, a lactam co-solvent at a lactam co-solvent to pigment weight ratio from 10:1 to 1:10, and water to provide a pre-mix dispersion. An additional step can include milling 120 the pre-mix dispersion in a milling vessel to prepare the pigment dispersion until an at least 5 wt % portion of the lactam co-solvent is adsorbed on the pigment via van der waals interaction with the amide group. In one example, the portion that becomes adsorbed can be from 5 wt % to 50 wt % of the lactam co-solvent.

In some examples, milling can be carried out by mixing the pigment dispersion with a rigid media and milling the mixture in high speed milling equipment until the particle size of the dispersion reaches a target value (such as those described above) and/or until a target amount of the lactam co-solvent adsorbs onto the pigment. Milling can be performed using any suitable grinding mill. Suitable mills can include an airjet mill, a roller mill, a ball mill, an attritor mill, or a bead mill, for example. In some specific examples, milling can be performed in a bead milling device in the presence of a bead having a diameter of from about 0.05 mm to about 2 mm, or from about 0.1 mm to about 1 mm.

In some specific examples, the pigment can be milled to an average particle size of from 60 nm to 160 nm. In further examples, the pigment can be milled to an average particle size from about 80 nm to about 150 nm. In yet other examples, the pigment can be milled to an average particle size from about 90 nm to about 130 nm or about 140 nm.

Milling can be performed at a variety of milling energies. In some specific examples, milling can be performed at a milling energy of from about 100 kilowatt-hour (kwh)/ton to 500 kwh/ton. In yet other examples, milling can be performed at a milling energy of from about 100 kwh/ton to about 300 kwh/ton, or from about 200 kwh/ton to about 400kwh/ton, or from about 300 kwh/ton to about 500 kwh/ton.

In some examples, filtering can be carried out after milling. Where this is the case, a variety of filter chemistries and pore sizes can be used. In some examples, a filter with a pore size of about 0.3 microns to about 5 microns can be used. Non-limiting examples of filter chemistries can include polyacrylic, polypropylene, glass fiber, or the like.

The pigment dispersion can also be admixed with an ink vehicle to form an ink. The ink can include a pigment dispersion having from about 5 wt % to about 30 wt % of a pigment having an amide group, a styrene acrylic polymer having a weight average molecular weight (Mw) from about 3,000 Mw to about 30,000 Mw and having a weight ratio to the pigment of from 1:1 to 1:10, a lactam co-solvent having a weight ratio to the pigment of from 10:1 to 1:10, and water. The lactam co-solvent can be co-milled with the pigment and an at least 5 wt % portion of the lactam co-solvent can be adsorbed on the pigment via van der waals interactions with the amide group on the pigment. In some specific examples, the lactam co-solvent can have a structure according to Formula I:

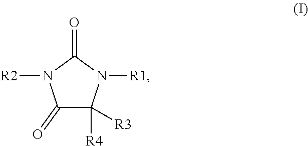

where R1 and R2 are independently selected from H or a C₁-C₆ hydroxy alkyl group, and where R3 and R4 are independently selected from H or a C₁-C₃ alkyl group.

In some examples, an ink vehicle can be admixed with the pigment dispersion to provide an ink having from 1 wt % to 8 wt % pigment. Thus, when preparing the ink, the weight percentage of the pigment is reduced by the addition of the ink vehicle components. In other examples, the ink vehicle can be admixed with the pigment dispersion to provide an ink having from 1.5 wt % to 6 wt % pigment, or from 2 wt % to 5 wt % pigment.

The ink vehicle can include a variety of additives. Non-limiting examples can include a solvent, a surfactant, an anti-kogation agent, an anti-decel agent, a pH adjuster or buffer, a biocide, a binder, the like, or a combination thereof.

Non-limiting examples of solvents can include water, aliphatic alcohols, aromatic alcohols, diols, triols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. For example, solvents can include primary aliphatic alcohols of 30 carbons or less, primary aromatic alcohols of 30 carbons or less, secondary aliphatic alcohols of 30 carbons or less, secondary aromatic alcohols of 30 carbons or less, 1,2-diols of 30 carbons or less, 1,3-diols of 30 carbons or less, 1,5-diols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, lactams, substituted formamides, unsubstituted formamides, substituted acetamides, and unsubstituted acetamides. Specific examples of certain solvents that may likewise be used include, but are not limited to, hydantoin glycol (such as, e.g., 1,3-bis-(2-hydroxyethyl)-5,5-dimethylhydantoin), 1,(2-hydroxyethyl)-2-pyrrolidinone, 1-(2-hydroxyethyl)-2-imidazolidinone, tetratethylene glycol, 1,2,6-hexanetriol, glycerol, glycerol propoxylate, 1,5-pentanediol, LIPONIC™ ethoxylated glycerol 1 (LEG-1), LIPONIC™ ethoxylated glycerol 7 (LEG-7), 2-methyl-2,4-pentanediol, 2-methyl-1,3-propanediol, 2-ethyl-2-hydroxymethyl-1,3-propanediol, diethylene glycol, 3-methoxybutanol, propylene glycol monobutyl ether, 1,3-dimethyl-2-imidazolidinone, the like, or combinations thereof. Solvents can be added to reduce the rate of evaporation of water in the inkjet ink, to minimize clogging, or provide other improved properties related to viscosity, pH, surface tension, optical density, gamut, durability, decap, and print quality, for example.

Non-limiting examples of suitable surfactants can include a nonionic surfactant, an anionic surfactant, or a combination thereof. In one example, the surfactant can be a nonionic surfactant. Several commercially available nonionic surfactants that can be used in the formulation of the green ink can include ethoxylated alcohols such as those from the Tergitol® series (e.g., Tergitol® 15S30, or Tergitol® 15S9), manufactured by Dow Chemical; surfactants from the Surfynol® series (e.g. Surfynol® 104, Surfynol® 440 and Surfynol® 465), and Dynol™ series (e.g. Dynol™ 360, Dynol™ 604, and Dynol™ 607) manufactured by Air Products and Chemicals, Inc.; fluorinated surfactants, such as those from the Zonyl® family (e.g., Zonyl® FSO and Zonyl® FSN surfactants), manufactured by E.I. DuPont de Nemours and Company; alkoxylated surfactant such as Tego® Wet 510 manufactured from Evonik; fluorinated PolyFox® nonionic surfactants (e.g., PF159 nonionic surfactants), manufactured by Omnova; or combinations thereof.

Polysorbate surfactants can include Polysorbate 20 (or polyoxyethylene 20 sorbitan monolaurate), Polysorbate 40 (or polyoxyethylene 20 sorbitan monopalmitate), Polysorbate 60 (or polyoxyethylene 20 sorbitan monostearate), Polysorbate 80 (or polyoxyethylene 20 sorbitan monooleate), or the like. However, not all of these polysorbates have at least 50 wt % lipophilic oleic acid groups and having an HLB value of less than 15. Brand names for these polysorbate surfactants include those sold under the tradename Tween® or Alkest®. Regarding the nomenclature of these polysorbates, the number “20” following “polyoxyethylene” refers to the total number of oxyethylene —(CH₂CH₂O)— groups found in the molecule. The number 20, 40, 60, or 80 following “polysorbate” is related to the type of fatty acid associated with the polyoxyethylene sorbitan portion. Monolaurate is indicated by 20, monopalmitate is indicated by 40, monostearate by 60 and monooleate by 80.

Other polysorbates can likewise be used, including Polysorbate 85, or Tween® 85, which is polyethylene glycol sorbitan trioleate; or Polysorbate 81, or Tween® 81, which is a polyoxyethylene (5) sorbitan monooleate. Tween® 85 and Tween® 81 are oleyl type compounds and include 70 wt % oleic acid. Polyoxyethylene sorbitan dioleate can also be used.

Another surfactant that can be used includes polyoxyethylene glycol ethers, including those having the base structure, as follows: CH₃(CH₂)ₙ(CH₂CH₂O)ₘH, where m can be from 2 to 100, but is typically from about 2 to about 20; and n can be from about 8 to 20. In one particular example, the polyoxyethylene glycol ether can have a tolerance of up to 1 “cis” unsaturated (oleyl) group, e.g., 0 or 1 “cis” group (which would reduce the total number of hydrogen atoms by 2 in the base structure described above, as a double bond would exist along the alkyl chain portion of the formula. Thus, oleyl type surfactants are included in this definition, even though they do not strictly fit within the above structural formulation, as the formulation is provided merely for convenience. Examples surfactants that can be used include Brij® S, Brij® O, Brij® C, and Brij® L type surfactants Synperonic surfactants can also be used. Specific examples include Brij® S10, Brij® S5, Brij®, S15, Brij® S20, Brij® S2/93, Brij® S7, Brij® 98/O20, Brij® O10, Brij® O2, Brij®, O3, Brij® O5, Brij® C2, Brij® C7, Brij® C10, Brij®, C20, Brij® L4/30, Brij® L9, Brij® L15, Synperonic® 91-2.5, Synperonic® 91-2.5, or Synperonic® 91-10, to name a few.

In some examples, the ink vehicle can also include an anti-kogation agent. The anti-kogation agent can be added to the ink vehicle to reduce or prevent kogation, i.e., where ink residue builds up on surfaces of the heating element of the printer during printing. In some examples the anti-kogation agent can include a phosphate ester surfactant, such as surfactants that are commercially available under the tradename Emphos®, DeSophoS®, Hostaphat®, ESI-Terge®, Emulgen®, Crodafos®, Dephotrope®, and DePhOS®, which are available from Witco Corp. (Middlebury, Conn.), Clariant GmbH (Frankfurt, Germany), Cook Composites and Polymers Co., (Kansas City, Mo.), Kao Specialties Americas LLC (High Point, Nalco), Croda Inc. (Parsippany, N.J.), DeForest Enterprises, Inc, (Boca Raton, Fla.), and DeForest Enterprises, Inc. (Boca Raton, Fla.), respectively.

Other known additives can also be included, such as biocide for inhibiting growth of undesirable microorganisms. Several non-limiting examples of suitable biocides include benzoate salts, sorbate salts, and commercial products such as Nuosept®, Ucarcide®, Vancide®, Proxel® GXL, Anticide® B20 or M20, Kordex® MLX, for example.

Any suitable pH adjuster can also be included. For example, pH adjusters can include both organic and inorganic acids and organic and inorganic bases. In some specific examples, the pH adjuster can include hydrochloric acid, phosphoric acid, sodium hydroxide, potassium hydroxide, acetic acid, citric acid, ammonia, triethylamine, the like, or combinations thereof. pH adjusters can also include pH buffers and any suitable pH buffer can be included in the green ink formulation. Non-limiting examples can include phosphate buffers, citrate buffers, phosphonate buffers, the like, or combinations thereof.

A variety of binders can also be used. Non-limiting examples of binders can include polyurethanes, polyurethane with a curable double bond, polyurethane-graph polyol, latex polymers, polyureas, polyacrylics, the like, or combinations thereof. In some examples, the polymeric binder can include, but is not limited to, a thermoplastic polymer. In some specific examples the binder can be selected from olefin resins, for example, polyalkylene resins such as polyethylene resin, polypropylene resin, polybutylene resin, and polyisobutylene resin; copolymers of styrene and derivatives thereof, such as butadiene-styrene copolymer, isoprene-styrene copolymer, styrene-methacrylate copolymer, styrene-acrylate copolymer, styrene-maleic resins; vinyl resin, for example, ethylene-vinyl acetate copolymer resins, vinyl chloride-vinyl acetate copolymer resins, vinyl acetate resins, and ethylene-vinyl chloride-vinyl acetate copolymer resins; acrylic resins, for example, methacrylic acid ester resins, polyacrylic acid ester resins, ethylene-ethyl acrylate copolymer resins, and ethylene-methacrylic acid ester copolymer resins; phenol resins; polyurethane resins; polyamide resins; polyester resins; ketone resins; rosin resins; epoxy resins; alkyd resins; maleic acid resins; butyral resins; terpene resins; petroleum resins, such as aliphatic hydrocarbon resins, aromatic modified aliphatic hydrocarbon resins, and aromatic modified, cycloaliphatic hydrocarbon resins; and hydrogenated terpene resins. These binders can be employed singly or as a mixture of two or more kinds thereof.

In some examples, the binder can include polyalkylene resins, for example, polyethylene resin, polypropylene resins, polybutylene resin and polyisobutylene resin, which can be employed singly or in combination with other polyalkylene resin(s), or the other binders described above, for example, a petroleum resin, such as aliphatic hydrocarbon resin, aromatic modified aliphatic hydrocarbon resin, and/or aromatic modified cycloaliphatic hydrocarbon resins.

In some examples, the binder can include a copolymer of styrene and derivatives thereof, for example, butadiene-styrene copolymer, isoprene-styrene copolymer, styrene-methacrylate copolymer and styrene-acrylate copolymer, which can be employed singly or in combination with other copolymer(s) of styrene or the other polymeric binder resins described above. In some examples, the binder can include or is a styrene-acrylate copolymer, for example, a derivatized styrene-acrylate copolymer, for example, a substituted styrene acrylate polymer, examples of which include Piloway®Ultra200 and Piloway®Ultra350 available from Eliokem®. In some examples, the styrene-copolymer, for example, styrene-acrylate copolymer, is substituted, i.e., has a substituent on the aromatic ring of the styrene moiety. In some examples, the substituent is selected from alky, alkenyl, alkynyl, alkenyl or alkoxy. The alkyl substituent(s) can be a C₁-C₆, straight or branched chain group, for example, methyl, ethyl, propyl, isopropyl, butyl, t-butyl, penty or hexyl. The alkenyl substituent(s) can be a C₂-C₆ group, for example, ethenyl (vinyl), propenyl, butenyl, pentenyl, or hexenyl. The alkynyl substituent(s) can be ethynyl, propynyl, butynyl, pentynyl or hexynyl. The alkoxy substituent(s) can be a C₁-C₅ alkoxy group, for example, methoxy, ethoxy, propoxy, butoxy, or pentoxy. In some examples, the aromatic ring of the styrene moiety is substituted with a methyl group. In some examples, the aromatic ring of the styrene moiety is substituted with a vinyl group. In some examples, the aromatic ring of the styrene moiety is substituted at more than one position, for example, two substituents, for example, three substituents. The substituent groups can be located meta, para or ortho about the aromatic ring. The substituents can be selected from any of the substituents described above. In some examples, the styrene moiety is substituted with a methyl group and a vinyl group (i.e., forming a vinyl toluene moiety).

It is noted that, as used in this disclosure, the singular forms “a,” “an,” and “the” include plural referents unless the context clearly dictates otherwise. Thus, for example, reference to “an inkjet ink” includes one or more of such inks, and reference to “the pigment” includes reference to one or more amounts of pigments.

As used herein, “liquid vehicle” or “ink vehicle” refers to the liquid fluid in which colorant is dispersed or dissolved to form an ink. Liquid vehicles include wide variety of liquid formulations and may be used in accordance with examples of the present disclosure. Such liquid vehicles may include a mixture of a variety of different agents, including without limitation, surfactants, organic co-solvents, buffers, biocides, viscosity modifiers, sequestering agents, stabilizing agents, and/or water. The liquid vehicle can also carry other additives such as latex particulates, binders, or other polymers, in some embodiments. In further detail, the term “ink vehicle” refers specifically to the vehicle that carries the pigment to form the inks of the present disclosure.

As used herein, “ink” or “inkjet ink” refers to a single liquid vehicle that contains at least one pigment, and in accordance with embodiments of the present disclosure, the inks can also include certain more specific ingredients, including certain polymers and co-solvent. In one example, the inkjet ink can be a thermal inkjet ink.

As used herein, “pigment” refers to a colorant particle which is typically substantially insoluble in the liquid vehicle in which it is used. Pigments can be conventionally dispersed using a separate dispersing agent, or can be self-dispersed, having a dispersing agent attached to the surface of the pigment.

As used herein, “self-dispersed” generally refers to pigments that have been functionalized with a dispersing agent, such as by chemical attachment of the dispersing agent to the surface of the pigment. The dispersing agent can be a small molecule or a polymer or an oligomer. The dispersing agent can be attached to such pigments to terminate an outer surface of the pigment with a charge, thereby creating a repulsive nature that reduces agglomeration of pigment particles within the liquid vehicle.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

As a further note, in the present disclosure, it is noted that when discussing pigment dispersions, methods of manufacturing pigment dispersions, and inks, each of these discussions can be considered applicable to each of these examples, whether or not they are explicitly discussed in the context of that example. Thus, for example, in discussing details about the pigment dispersion per se, such discussion also refers to the methods and the inks described herein, and vice versa.

### EXAMPLES

The following examples illustrate the embodiments of the disclosure that are presently best known. However, it is to be understood that the following are only exemplary or illustrative of the application of the principles of the present technology. Numerous modifications and alternative compositions and methods may be devised by those skilled in the art without departing from the spirit and scope of the present disclosure. The appended claims are intended to cover such modifications and arrangements.

### Example 1

### Pigment Dispersion Formulations

Various pigment dispersions were prepared with different milling solvents. The various components of each dispersion were placed in a bead miller and milled to a desired particle size range. Four example pigment dispersions are recited in Tables 1-4:

TABLE 1
Pigment Dispersion 1

| Ingredient | Type | Wt % |
|---|---|---|
| 1,2 Butanediol | Milling Solvent | 12 |
| Styrene Acrylic Polymer | Dispersant | 3 |
| Pigment with amide group | Pigment | 15 |
| Water | Solvent | Balance |

pH adjusted/neutralized using potassium hydroxide

TABLE 2
Pigment Dispersion 2

| Ingredient | Type | Wt % |
|---|---|---|
| 2-Methyl-1,3-Propanediol | Milling Solvent | 12 |
| Styrene Acrylic Polymer | Dispersant | 3 |
| Pigment with amide group | Pigment | 15 |
| Water | Solvent | Balance |

pH adjusted/neutralized using potassium hydroxide

TABLE 3
Pigment Dispersion 3

| Ingredient | Type | Wt % |
|---|---|---|
| 2-Hydroxyethyl-2-Pyrrolidone | Milling Solvent | 12 |
| Styrene Acrylic Polymer | Dispersant | 3 |
| Pigment with amide group | Pigment | 15 |
| Water | Solvent | Balance |

pH adjusted/neutralized using potassium hydroxide

TABLE 4
Pigment Dispersion 4

| Ingredient | Type | Wt % |
|---|---|---|
| Di-(2-Hydroxyethyl)-5,5- | Milling Solvent | 11.3 |
| Dimethylhydantoin | | |
| (DANTOCOL ® DHE) | | |
| Styrene Acrylic Polymer | Dispersant | 4.3 |
| Pigment with amide group | Pigment | 15 |
| Water | Solvent | Balance |

pH adjusted/neutralized using potassium hydroxide

### Example 2

### Pigment Dispersion Stability

The pigment dispersions described in Example 1 were subjected to stability testing to determine the impact of the various milling solvents on the overall stability of the pigment dispersions. The stability of the various pigment dispersions was determined by monitoring the pigment size over time. More specifically, the particle size was measured at a fixed time interval, e.g. every 10 minutes, during the milling until a desired particle size was achieved. The various pigment dispersions were then subjected to temperature cycle (T-cycle) testing and accelerated storage testing (ASL) at 60° C. T-cycle testing was performed by ramping the temperature between −40° C. and 70 ° C. followed by a 4 hour temperature hold for 22 cycles. The results of the stability testing are presented in Table 5:

TABLE 5

| | Initial | | | After 1 | |
|---|---|---|---|---|---|
| | Particle | After T- | % Increase | Wk 60° C. | % Increase |
| Pigment | Size | Cycle | After T- | ASL | After 1 Wk |
| Dispersion | (nm) | (nm) | Cycle | (nm) | ASL |
| 1 | 110 | 197 | 79.09% | 145 | 31.82% |
| 2 | 101 | 115 | 13.86% | 110 | 8.91% |
| 3 | 114 | 113 | −0.88% | 120 | 5.26% |
| 4 | 121 | 123 | 1.65% | 125 | 3.31% |

As demonstrated by the results provided in Table 5, the stability of pigment dispersions 3 and 4, which included lactam milling solvents, was superior to the stability of pigment dispersions 1 and 2, which did not include a lactam milling solvent. It is noted that a % increase in pigment average particle size within 10% is generally acceptable. Thus, pigment dispersion 1 failed this criteria for both T-cyle and Accelerated Shelf Life (ASL) testing and pigment dispersion 2 failed this criteria for T-cycle testing. In contrast, pigment dispersions 3 and 4 met this criteria for both T-cycle testing and ASL testing.

Additional stability testing was performed on variations of pigment dispersion 4. Specifically, the amount of DANTOCOL® DHE to prepare six different pigment dispersions was varied. The results of this stability testing is illustrated in Table 6:

TABLE 6

| Pigment | Initial | After | | 1 Wk | | 2 Wk | | 3 Wk | |
|---|---|---|---|---|---|---|---|---|---|
| to Solvent | Particle Size | T-Cycle | % Increase | ASL | % Increase | ASL | % Increase | ASL | % Increase |
| Ratio | (nm) | (nm) | (T-Cycle) | (nm) | (1 Wk ASL) | (nm) | (2 Wk ASL) | (nm) | (3 Wk ASL) |
| 1.00 | 116 | 123 | 6.03% | 118 | 1.72% | 119 | 2.59% | 120 | 3.45% |
| 1.25 | 121 | 119 | −1.65% | 123 | 1.65% | 117 | −3.31% | 119 | −1.65% |
| 1.34 | 121 | 123 | 1.65% | 125 | 3.31% | 121 | 0.00% | 122 | 0.83% |
| 1.67 | 121 | 125 | 3.31% | 131 | 8.26% | 125 | 3.31% | 125 | 3.31% |
| 2.00 | 125 | 119 | −4.80% | 124 | −0.80% | 132 | 5.60% | 128 | 2.40% |
| 2.50 | 124 | 118 | −4.84% | 123 | −0.81% | 120 | −3.23% | 123 | −0.81% |

As demonstrated by the results provided in Table 6, each of the amide-containing pigment dispersions prepared with DANTOCOL® DHE met the criteria for less than or equal to 10% increase in pigment average particle size for each time point tested.

### Example 3

### Adsorption of Lactam Co-Solvent

A study was performed to determine what affect milling the amide-containing pigment with the lactam co-solvent had as compared to merely adding the lactam co-solvent to the ink vehicle. As such, two pigment dispersions were prepared to compare the effects of milling with and without the lactam co-solvent. Both pigment dispersions included approximately 9 wt % DANTOCOL® DHE. Pigment dispersion 1 was prepared by milling the pigment with DANTOCOL® DHE. Pigment dispersion 2 was prepared by adding DANTOCOL® DHE after milling as part of the pigment dispersion composition. Both of these pigment dispersions were subsequently evaluated using liquid chromatography with mass spectrometry detection to determine the extent to which the lactam co-solvent adsorbed onto the pigment particles. The results are illustrated in Table 7:

TABLE 7

| Pigment | Non-Adsorbed | Adsorbed | Total |
|---|---|---|---|
| Dispersion | (wt %) | (wt %) | (wt %) |
| 1 | 6.9 | 2 | 8.9 |
| 2 | 8.7 | 0.3 | 9 |

As indicated by the results provided in Table 7, milling the pigment with the lactam co-solvent increased the amount of solvent adsorbed onto the pigment particles. Milled Pigment Dispersion 1 adsorbed about 22 wt % of the lactam co-solvent, whereas the non-milled Pigment Dispersion 2 only adsorbed about 3.3 wt % of the lactam co-solvent. In some examples, higher adsorption can increase the stability of the pigment dispersions and associated inks by helping to prevent pigment particle aggregation and precipitation.

While the present technology has been described with reference to certain examples, those skilled in the art will appreciate that various modifications, changes, omissions, and substitutions can be made without departing from the spirit of the disclosure. It is therefore intended that the disclosure be limited only by the scope of the appended claims.

What is claimed is:

1. A pigment dispersion, comprising:
from 5 wt % to 30 wt % of a pigment having an amide group;
a styrene acrylic polymer having a weight average molecular weight from 1,000 Mw to 30,000 Mw and a styrene acrylic polymer to pigment weight ratio from 1:1 to 1:10;
a lactam co-solvent having a lactam co-solvent to pigment weight ratio from 10:1 to 1:10, wherein the lactam co-solvent is co-milled with the pigment and an at least 5 wt % portion of the lactam co-solvent is adsorbed on the pigment via van der weals interaction with the amide group; and
water.

2. The pigment dispersion of claim 1, wherein the amide group of the pigment comprises an n-phenyl amide group.

3. The pigment dispersion of claim 1, wherein the pigment includes multiple amide groups.

4. The pigment dispersion of claim 1, wherein the amide group includes a tertiary amine.

5. The pigment dispersion of claim 1, wherein the pigment is Pigment Orange 43, Pigment Yellow 155, Pigment Yellow 74, Pigment Orange 34, Pigment Red 149, Pigment Red 269, Pigment Yellow 14, or a combination thereof.

6. The pigment dispersion of claim 1, wherein the styrene acrylic polymer is present in an amount from 1 wt % to 10 wt %, and has an acid number from 100 mg/g to 300 mg/g.

7. The pigment dispersion of claim 1, wherein the portion of the lactam co-solvent that is adsorbed on the pigment is from 5 wt % to 50 wt % of the lactam co-solvent.

8. The pigment dispersion of claim 1, wherein the lactam co-solvent has a structure according to Formula I: 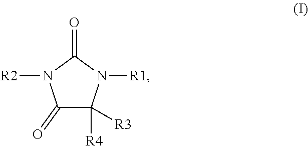
wherein R1 and R2 are independently H or a C₁-C₆ hydroxy alkyl group, and wherein R3 and R4 are independently H or a C₁-C₃ alkyl group.

9. The pigment dispersion of claim 8, wherein R1 and R2 are CH₂CH₂OH, and R3 and R4 are methyl.

10. A method of manufacturing a pigment dispersion, comprising:
combining 5 wt % to 30 wt % of a pigment having an amide group, a styrene acrylic polymer having a weight average molecular weight from 1,000 Mw to 30,000 Mw at a styrene acrylic polymer to pigment weight ratio from 1:1 to 1:10, a lactam co-solvent at a lactam co-solvent to pigment weight ratio from 10:1 to 1:10, and water, to formulate a pre-mix dispersion; and
milling the pre-mix dispersion in a milling vessel until an at least 5 wt % portion of the lactam co-solvent is adsorbed on the pigment via van der waals interaction with the amide group.

11. The method of claim 10, wherein the portion of the lactam co-solvent that is adsorbed on the pigment is from 5 wt % to 50 wt % of the lactam co-solvent.

12. The method of claim 10, wherein the pigment is milled to an average particle size of from 60 nm to 160 nm.

13. The method of claim 10, further comprising filtering the pigment dispersion after milling.

14. An ink, comprising:
a pigment dispersion, including:
from 5 wt % to 30 wt % of a pigment having an amide group;
a styrene acrylic polymer having a weight average molecular weight from 1,000 Mw to 30,000 Mw and styrene acrylic polymer to pigment weight ratio from 1:1 to 1:10;
a lactam co-solvent having a weight ratio to the pigment of from 10:1 to 1:10, wherein the lactam co-solvent is co-milled with the pigment and an at least 5 wt % portion of the lactam co-solvent is adsorbed on the pigment via van der waals interaction with the amide group; and
water; and
an ink vehicle admixed with the pigment dispersion to provide an ink having from 1 wt % to 8 wt % pigment.

15. The ink of claim 14, wherein the lactam co-solvent has a structure according to Formula I: 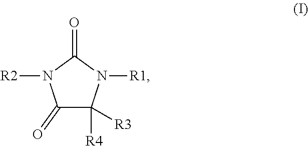
wherein R1 and R2 are independently H or a C₁-C₆ hydroxy alkyl group, wherein R3 and R4 are independently H or a C₁-C₃ alkyl group, and wherein the amide group of the pigment comprises an n-phenyl amide group.
